(19) United States
(12) Patent Application Publication
(10) Pub. No.: US 2017/0094410 A1
(43) Pub. Date: Mar. 30, 2017

(54) SPEAKER PARAMETER CONFIGURATION METHOD AND MOBILE TERMINAL

(71) Applicant: Guangdong Oppo Mobile Telecommunications Corp., Ltd., Dongguan (CN)

(72) Inventor: Shangbo Lin, Dongguan (CN)

(21) Appl. No.: 15/371,969

(22) Filed: Dec. 7, 2016

Related U.S. Application Data
(63) Continuation of application No. PCT/CN2015/096064, filed on Nov. 30, 2015.

(30) Foreign Application Priority Data
Jul. 9, 2015 (CN) 201510402365.1

(51) Int. Cl. H04R 3/04

(52) U.S. Cl. CPC H04R 3/04; H04R 2420/07; H04R 2499/11; H04W 88/02

(57) ABSTRACT

The present disclosure provides a speaker parameter configuration method and a mobile terminal. The method includes: transmitting a parameter configuration request containing a scene type combination of wireless speakers of a wireless speaker system; receiving a parameter configuration response sent from the server in response to the parameter configuration request, wherein the parameter configuration response contains at least one speaker parameter configuration record of the wireless speaker system matched with the scene type combination; and performing parameter configuration on the wireless speakers of the wireless speaker system by using the speaker parameter configuration record received.

### CROSS-REFERENCE TO RELATED APPLICATIONS

This application is a continuation of International Application No. PCT/CN2015/096064, filed on Nov. 30, 2015, which claims priority to Chinese patent application No. 201510402365.1, filed on Jul. 9, 2015, the disclosures of both of which are herein incorporated by reference in their entireties.

### TECHNICAL FIELD

The present disclosure relates to the field of electronic technology, and particularly to a speaker parameter configuration method and a mobile terminal.

### BACKGROUND

In a wireless speaker system including a plurality of wireless speakers, the speakers can form a private network wirelessly. Generally, within this private network, a logical main wireless speaker can be configured to couple with a router in a wired or wireless manner so as to access an external network directly, and other slave speakers can access the external network via the main wireless speaker.

For a mobile terminal, in order to set a wireless speaker system through an APP, usually, the user has to add wireless speakers for different scenes into the wireless speaker system manually and create song catalogs, add tracks, as well as set volume, sound effect, and other speaker parameters.

### SUMMARY

Disclosed herein are implementations of a speaker parameter configuration method, comprising: transmitting a parameter configuration request comprising a scene type combination of wireless speakers of a wireless speaker system to a server, receiving a parameter configuration response sent from the server in response to the parameter configuration request, wherein the parameter configuration response comprises at least one speaker parameter configuration record matched with the scene type combination, and performing parameter configuration on the wireless speakers of the wireless speaker system by using the at least one speaker parameter configuration record received.

Disclosed herein are also implementations of a speaker parameter configuration method, the method comprising receiving a parameter configuration request comprising a scene type combination of wireless speakers of a wireless speaker system from a mobile terminal, and transmitting a parameter configuration response comprising at least one speaker parameter configuration record matched with the scene type combination to a control terminal.

Disclosed herein are also implementations of a mobile terminal, comprising: a transmitting unit, configured to transmit a parameter configuration request comprising a scene type combination of wireless speakers of a wireless speaker system to a server, a first receiving unit, configured to receive a parameter configuration response sent by the server in response to the parameter configuration request, wherein the parameter configuration response comprises at least one speaker parameter configuration record matched with the scene type combination, and a configuring unit, configured to perform parameter configuration on the wireless speakers of the wireless speaker system by using the at least one speaker parameter configuration record received.

### BRIEF DESCRIPTION OF THE DRAWINGS

In order to illustrate the technical solutions of the present disclosure or the related art more clearly, a brief description of the accompanying drawings used herein is given below. Obviously, the drawings listed below are only examples, and a person skilled in the art should be noted that, other drawings can also be obtained on the basis of these exemplary drawings without creative work.

FIG. 1 is a network architecture diagram according to an implementation of the present disclosure;

FIG. 2 is a schematic flowchart illustrating a speaker parameter configuration method according to an implementation of the present disclosure;

FIG. 3 is a schematic flowchart illustrating another speaker parameter configuration method according to an implementation of the present disclosure;

FIG. 4 is a schematic flowchart illustrating another speaker parameter configuration method according to an implementation of the present disclosure;

FIG. 5A and FIG. 5B are schematic structure diagrams illustrating a mobile terminal according to an implementation of the present disclosure;

FIG. 6A and FIG. 6B are schematic structure diagrams illustrating a server according to an implementation of the present disclosure;

FIG. 7 is a schematic structure diagram illustrating another mobile terminal according to an implementation of the present disclosure; and

FIG. 8 is an architecture diagram illustrating a speaker parameter configuration system according to an implementation of the present disclosure.

### DETAILED DESCRIPTION

Technical schemes of the present disclosure will be described in detail below with refer to implementations in conjunction with accompanying drawings. Implementations described herein are used to explain rather than restrict the present disclosure. Only relevant parts rather than the whole structure of the present disclosure are illustrated in the accompanying drawings.

Terms such as “first”, “second”, “third”, “fourth” and the like used herein aims to distinguish among different objects and is not intend to define a specific order. Terms such as “comprise”, “include”, or “have/has” used herein means a non-exclusive containment relationship. For example, a process, a method, a system, a product, or an apparatus described herein can include other steps or units in addition to those explained in the disclosure.

Specific features, structures, or characteristics can be included in at least one implementation of the present disclosure. Each implementation described herein can be combined with other implementations without confliction.

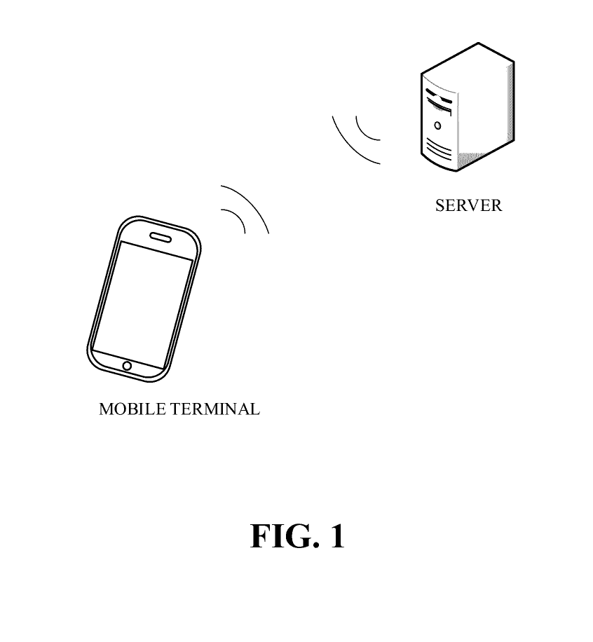

In order to better understand the speaker parameter configuration method, the mobile terminal, the server, and the system of the present disclosure, a network architecture to which implementations of the present disclosure can be applied will be described. FIG. 1 is diagram illustrating the network architecture according to an implementation of the present disclosure. As illustrated in FIG. 1, the network architecture includes a mobile terminal and a server, among which the mobile terminal can be coupled to the server wirelessly (such as via Wi-Fi, mobile communication network) for communication. The mobile terminal referred to can be a mobile phone, a tablet PC, a Personal Digital Assistant (PDA), a Mobile Internet Device (MID), an intelligent wearable device (such as smart watch, smart Bracelet), and other mobile terminals, the present disclosure is not limited thereto. With aid of the network architecture illustrated in FIG. 1, picture display at the mobile terminal can be more interesting and user experience can be improved.

Implementation 1

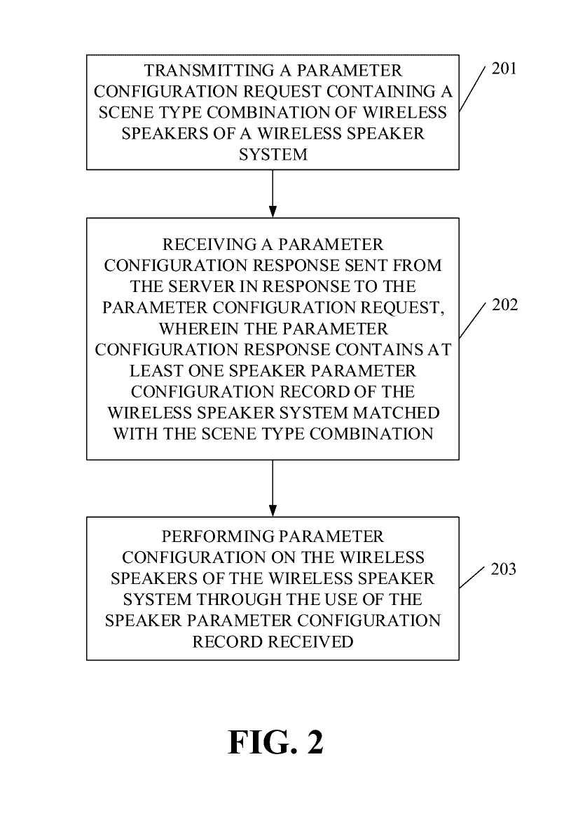

Based on the network architecture illustrated in FIG. 1, the present discourse provides a speaker parameter configuration method for a wireless speaker system. FIG. 2 is a schematic flowchart illustrating the method. As illustrated in FIG. 2, the speaker parameter configuration method can be performed at a mobile terminal side and can begin at block 201.

At block 201, a parameter configuration request carrying a scene type combination of wireless speakers of a wireless speaker system is transmitted to a server.

In one implementation, the process of transmitting the parameter configuration request carrying the scene type combination of wireless speakers of the wireless speaker system to the server includes the following operations: receiving a creating instruction concerning the wireless speaker system from the user; acquiring the scene type combination formed by scene types of the wireless speakers added in the creating instruction; and transmitting the parameter configuration request carrying the scene type combination of the wireless speakers to the server.

The wireless speaker system is a music playing system including a plurality of speakers (such as a wireless speaker, a Bluetooth speaker, an intelligent speaker, and the like) via a private network (such as a MESH network). In the music playing system, a logical main speaker can be designated to conduct data and control instruction interactions with an APP installed in a control terminal of the user via a home network (such as a Wi-Fi network); after receiving an instruction sent through an APP of the mobile terminal from the user, the main speaker can transfer the instruction to other wireless speakers of the wireless speaker system via the private network of the wireless speaker system.

For example, a wireless speaker system is provided with a bedroom speaker, a living room speaker 1, and a living room speaker 2. Through an APP installed on a smart phone, the user can set the volume of the bedroom speaker to be 10 as well as set the volume of the living room speaker 1 and the living room speaker 2 to be 15, among which the bedroom speaker is designated to be the main device of the wireless speaker system. In this situation, after receiving a control instruction configured to set the volume of the wireless speaker system from the mobile terminal, the bedroom speaker will transfer this control instruction to the living room speaker 1 and the living room speaker 2 respectively via the private network of the wireless speaker system.

The scene type combination of wireless speakers of the wireless speaker system can include the room type or location type of a room or location that the wireless speaker system belongs to. The room type or location type includes one or more of bedroom, living room, study room, kitchen, garden, bath room, or other common household room or location.

For example, a wireless speaker system includes three wireless speakers, that is, “Bedroom 1”, “Bedroom 2”, and “Study room”; in this case, the scene type combination of wireless speakers of the wireless speaker system includes (bedroom; study room).

As another example, a wireless speaker system includes three wireless speakers, that is, “Living room 1”, “Living room 2”, and “Living room 3”; in this case, the scene type combination of wireless speakers of the wireless speaker system includes (living room).

At block 202, a parameter configuration response sent by the server in response to the parameter configuration request is received; the parameter configuration response contains at least one speaker parameter configuration record matched with the scene type combination.

Parameters in the speaker parameter configuration record matched with the scene type combination of the wireless speakers can include a volume parameter value or sound effect parameter value of a wireless speaker or one or more other parameters configured to set the attribute of playing of the wireless speaker.

### Example 1

It can be understood that, the speaker parameter configuration record matched with the scene type combination of the wireless speakers can be implemented in various forms such as those listed below:

{system 1: living room speaker (volume 11, sound effect 11), bedroom speaker (volume 12, sound effect 12)};

{system 1: living room speaker (volume 13, sound effect 13), bedroom speaker (volume 14, sound effect 14)};

{system 1: living room speaker (volume 12, sound effect 12), bedroom speaker (volume 16, sound effect 16)}.

Among which the scene type combination of wireless speakers of the wireless speaker system 1 includes (living room; bedroom).

### Example 2

As another example, the at least one speaker parameter configuration record matched with the scene type combination of the wireless speakers can also be implemented in the forms listed below:

{system 1: 07:00; living room speaker (volume 11), bedroom speaker (volume 12)};

{system 1: 07:30; living room speaker (volume 13), bedroom speaker (volume 14)};

{system 1: 08:30; living room speaker (volume 12), bedroom speaker (volume 16)}.

Among which the scene type combination of wireless speakers of the wireless speaker system 1 can include (living room; bedroom). “Time” appeared in each speaker parameter configuration record refers to the moment (24-hour system) at which the volume parameter of the living room speaker/bedroom speaker is set by user.

At block 203, parameter configuration is performed on the wireless speakers of the wireless speaker system through the use of the speaker parameter configuration record received.

In one implementation, the process of parameter configuration at block 203 can be implemented as follows: the control terminal generates a target speaker parameter configuration record based on the speaker parameter configuration record received, and configures the wireless speakers of the wireless speaker system in accordance with the target speaker parameter configuration record.

Speaker Parameter Configuration Record

In real practice, there can be more than one speaker parameter configuration record received. Based on this, the mobile terminal can generate the target speaker parameter configuration record based on any of a plurality of speaker parameter configuration records received. Or, the mobile terminal can generate the target speaker parameter configuration record based on the all of the plurality of speaker parameter configuration records received.

### Example 1

The mobile terminal can generate the target speaker parameter configuration record based on a plurality of speaker parameter configuration records received as follows: suppose the number of speaker parameter configuration records is N, and in each speaker parameter configuration record, the number of speakers is Y and the number of parameter types is X; based on this fact, in the target speaker parameter configuration record, the value of Parameter j of Speaker i (wherein i is an integer between 1 to Y) is set to be equal to the average value of the sum of Parameters j of Speaker i in each speaker parameter configuration record; wherein Y, X, N are positive integers, Speaker i is any speaker among the speakers (that is, Speaker 1, Speaker 2, . . . Speaker i, . . . , Speaker Y), and Parameter j is any parameter type among the parameter types (that is, Parameter 1, Parameter 2, . . . Parameter j, . . . , Parameter X).

For example, three speaker parameter configuration records (N=3) are transmitted to the mobile terminal form the server, that is:

{system 1: living room speaker (volume 11, sound effect 11), bedroom speaker (volume 12, sound effect 12)};

{system 1: living room speaker (volume 13, sound effect 13), bedroom speaker (volume 14, sound effect 14)};

{system 1: living room speaker (volume 12, sound effect 12), bedroom speaker (volume 16, sound effect 16)};

in accordance with the formula

$${P}_{ij} = \frac{1}{N} * {\sum }_{k = 1}^{N} {P}_{ijk} ,$$

wherein i, j, k, and N are integers, i is the serial number of a speaker, j is the serial number of a parameter type of the speaker, k is the serial number of a speaker parameter configuration record, and N is the number of the at least one speaker parameter configuration record, the target speaker parameter configuration record can be calculated as follows:

{system 1: living room speaker (volume (11+13+12)/3, sound effect (11+13+12)/3), bedroom speaker (volume (12+14+16)/3, sound effect (12+14+16)/3};

that is, system {: living room speaker (volume 12, sound effect 12), bedroom speaker (volume 14, sound effect 14}.

### Example 2

As another example, the mobile terminal can extract a specific speaker parameter configuration record from the plurality of speaker parameter configuration records; the specific speaker parameter configuration record has a minimum relative time difference between a record creating time and a receiving time of the parameter configuration request. Influence of a specific date on the record creating time and/or the receiving time is not considered when determining the relative time difference, which will be defined in the 24-hour system only. For example, suppose the record creating time in the plurality of speaker parameter configuration records is Setting time 1 (7:40′20″ am), Setting time 2 (7:50′30″ am), Setting time 3 (7:35′20″ am), and the receiving time of the parameter configuration request is 8:40′20″ am, based on this, the mobile terminal will extract the speaker parameter configuration record corresponding to Setting time 2.

After the target speaker configuration record is generated, the mobile terminal can transmit a configuration instruction to a main speaker of the wireless speaker system via a home network such as a Wi-Fi network, wherein, the configuration instruction for indicating performing parameter configuration on wireless speakers of the wireless speaker system through the use of the target speaker parameter configuration record. After the configuration instruction is received, the main speaker can transfer the configuration instruction to other wireless speakers of the wireless speaker system via a private network (such as a MESH network) of the wireless speaker system described above, whereby other speakers can perform parameter configuration through the use of the target speaker parameter configuration record.

Through the technical scheme described above, the mobile terminal can transmit the parameter configuration request carrying the scene type combination of wireless speakers of the wireless speaker system to the server and then receive the parameter configuration response, which is transmitted by the server in response to the parameter configuration request and contains a speaker parameter configuration record matched with the scene type combination; thereafter, the mobile terminal can perform parameter configuration on the wireless speakers of the wireless speaker system through the use of the speaker parameter configuration record received. The technical scheme has advantages that, with aid of the speaker parameter configuration record received, active settings can be conducted by the mobile terminal without the need to set manually by user, therefore, convenience of speaker parameter configuration of the mobile terminal can be enhanced and user experience can be improved.

Song Catalog

As another implementation, after configuring wireless speakers of the wireless speaker system through the use of the speaker parameter configuration record received, the mobile terminal can further receive at least one song catalog matched with the scene type combination and control the wireless speakers of the wireless speaker system to play songs corresponding to the song catalog.

The server connected with the mobile terminal for communication can be configured to store one or more song catalogs matched with the scene type combination of the wireless speakers with the wireless speaker system. For example, the scene type combination is (bedroom; living room), and the song catalog matched with this scene type combination can include Song Catalog 1 (song 1, song 2, song 3), Song Catalog 2 (song 4, song 5, song 6), and Song Catalog 3 (song 8, song 9, song 10).

In one instance, the server can extract a song catalog matched with the scene type combination of the wireless speakers randomly, for example, select Song Catalog 2 (song 4, song 5, song 6) matched with the scene type combination (bedroom; living room).

In another instance, the server can extract a combination of more than one song catalog matched with the scene type combination of the wireless speakers, for example, select a combination of Song Catalog 2 (song 4, song 5, song 6) and Song Catalog 3 (song 8, song 9, song 10) matched with the scene type combination (bedroom; living room). As to the manner of song catalog combination, for example, the server can transmit corresponding song catalogs to the mobile terminal for the user to free combine and match so as to obtain the song catalog for the wireless speaker system to use.

If each song catalog relates to a catalog creating time, the server can extract a specific song catalog among a plurality of song catalogs as the song catalog to be used by the wireless speaker system, among which, the specific song catalog has a minimum relative time difference (24-hour system) between the catalog creating time and the receiving time of the parameter configuration request.

With aid of the above technical scheme, the mobile terminal can receive one or more song catalogs sent by the server and control the wireless speaker system to play songs corresponding to the song catalog received, therefore, convenience of song catalog setting of the wireless speaker system by the mobile terminal can be enhanced and user experience can be improved.

Implementation 2

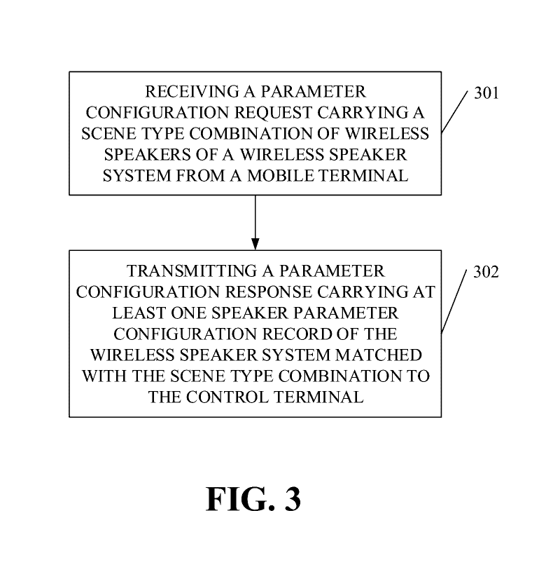

Based on the network architecture as illustrated in FIG. 1, the present disclosure provides a speaker parameter configuration method for a wireless speaker system and FIG. 3 is a schematic flowchart illustrating the method. As illustrated in FIG. 3, the speaker parameter configuration method can be performed at a server side and can begin at block 301.

At block 301, a parameter configuration request carrying a scene type combination of wireless speakers of a wireless speaker system is received from a mobile terminal.

The wireless speaker system is a music playing system including a plurality of speakers (such as a wireless speaker, a Bluetooth speaker, an intelligent speaker, and the like) via a private network (such as a MESH network). In the music playing system, a logical main speaker can be designated to conduct data and control instruction interactions with an APP installed in a control terminal of the user via a home network (such as a Wi-Fi network); after receiving an instruction sent through an APP of the mobile terminal from the user, the main speaker can transfer the instruction to other wireless speakers of the wireless speaker system via the private network of the wireless speaker system.

For example, a wireless speaker system is provided with a bedroom speaker, a living room speaker 1, and a living room speaker 2. Through an APP installed on a smart phone, the user can set the volume of the bedroom speaker to be 10 as well as set the volume of the living room speaker 1 and the living room speaker 2 to be 15, among which the bedroom speaker is designated to be the main device of the wireless speaker system. In this situation, after receiving a control instruction configured to set the volume of the wireless speaker system from the mobile terminal, the bedroom speaker will transfer this control instruction to the living room speaker 1 and the living room speaker 2 respectively via the private network of the wireless speaker system.

The scene type combination of wireless speakers of the wireless speaker system can include the room type or location type of a room or location that the wireless speaker system belongs to. The room type or location type includes one or more of bedroom, living room, study room, kitchen, garden, bath room, or other common household room or location.

For example, a wireless speaker system includes three wireless speakers, that is, “Bedroom 1”, “Bedroom 2”, and “Study room”; in this case, the scene type combination of wireless speakers of the wireless speaker system includes (bedroom; study room).

As another example, a wireless speaker system includes three wireless speakers, that is, “Living room 1”, “Living room 2”, and “Living room 3”; in this case, the scene type combination of wireless speakers of the wireless speaker system includes (living room).

S302, a parameter configuration response carrying at least one speaker parameter configuration record matched with the scene type combination is transmitted to the control terminal, whereby the mobile terminal can perform parameter configuration on the wireless speakers of the wireless speaker system through the use of the speaker parameter configuration record received.

Parameters in the speaker parameter configuration record matched with the scene type combination of the wireless speakers can include a volume parameter value or sound effect parameter value of a wireless speaker or one or more other parameters configured to set the attribute of playing of the wireless speaker.

### Example 1

It can be understood that, the speaker parameter configuration record matched with the scene type combination of the wireless speakers can be implemented in various forms such as those listed below:

{system 1: living room speaker (volume 11, sound effect 11), bedroom speaker (volume 12, sound effect 12)};

{system 1: living room speaker (volume 13, sound effect 13), bedroom speaker (volume 14, sound effect 14)};

{system 1: living room speaker (volume 12, sound effect 12), bedroom speaker (volume 16, sound effect 16)}.

Among which the scene type combination of wireless speakers of the wireless speaker system 1 includes (living room; bedroom).

### Example 2

As another example, the speaker parameter configuration record matched with the scene type combination of the wireless speakers can also be implemented in the forms listed below:

{system 1: 07:00; living room speaker (volume 11), bedroom speaker (volume 12)};

{system 1: 07:30; living room speaker (volume 13), bedroom speaker (volume 14)};

{system 1: 08:30; living room speaker (volume 12), bedroom speaker (volume 16)}.

Among which the scene type combination of wireless speakers of the wireless speaker system 1 can include (living room; bedroom). “Time” appeared in each speaker parameter configuration record refers to the moment (24-hour system) at which the volume parameter of the living room speaker/bedroom speaker is set by user.

Through the technical scheme described above, the server can receive the parameter configuration request carrying the scene type combination of wireless speakers of the wireless speaker system and in response thereto, return the parameter configuration response containing at least one speaker parameter configuration record matched with the scene type combination; therefore, the mobile terminal can perform parameter configuration on the wireless speakers of the wireless speaker system through the use of the speaker parameter configuration record received. The technical scheme has advantages that, with aid of the speaker parameter configuration record received, active settings can be conducted by the mobile terminal without the need to set manually by user, therefore, convenience of speaker parameter configuration of the mobile terminal can be enhanced and user experience can be improved.

Song Catalog

As one implementation, after transmitting the parameter configuration response, the server can further transmit at least one song catalog matched with the scene type combination to the mobile terminal, whereby the control terminal can control the wireless speakers of the wireless speaker system to play songs corresponding to the song catalog.

One or more song catalogs matched with the scene type combination of the wireless speakers with the wireless speaker system can be stored in the server. For example, the scene type combination is (bedroom; living room), and the song catalog matched with this scene type combination can include Song Catalog 1 (song 1, song 2, song 3), Song Catalog 2 (song 4, song 5, song 6), and Song Catalog 3 (song 8, song 9, song 10).

In one instance, the server can extract a song catalog matched with the scene type combination of the wireless speakers randomly, for example, select Song Catalog 2 (song 4, song 5, song 6) matched with the scene type combination (bedroom; living room).

In another instance, the server can extract a combination of more than one song catalog matched with the scene type combination of the wireless speakers, for example, select a combination of Song Catalog 2 (song 4, song 5, song 6) and Song Catalog 3 (song 8, song 9, song 10) matched with the scene type combination (bedroom; living room). As to the manner of song catalog combination, for example, the server can transmit corresponding song catalogs to the mobile terminal for the user to free combine and match so as to obtain the song catalog for the wireless speaker system to use.

If each song catalog relates to a catalog creating time, the server can extract a specific song catalog among a plurality of song catalogs as the song catalog to be used by the wireless speaker system, among which, the specific song catalog has a minimum relative time difference (24-hour system) between the catalog creating time and the receiving time of the parameter configuration request.

With aid of the above technical scheme, the server can transmit one or more song catalogs to the mobile terminal such that the wireless speaker system can be controlled to play songs corresponding to the song catalog received, therefore, convenience of song catalog setting of the wireless speaker system by the mobile terminal can be enhanced and user experience can be improved.

Implementation 3

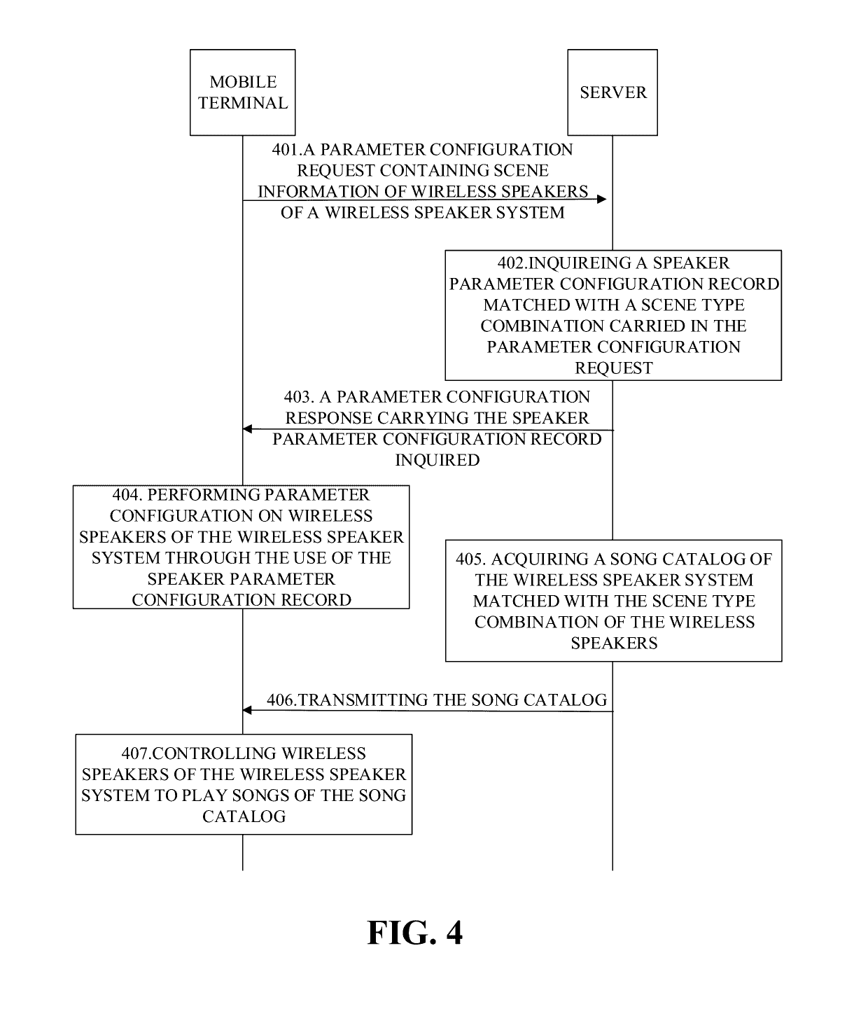

Based on the network architecture illustrated in FIG. 1, the present disclosure provides another speaker parameter configuration method for a wireless speaker system and FIG. 4 is a flowchart illustrating the method. As illustrated in FIG. 4, the speaker parameter configuration method can begin at block 401.

At block 401, a control terminal transmits a parameter configuration request carrying a scene type combination of wireless speakers of a wireless speaker system to a server.

At block 402, the server receives the parameter configuration request and inquires at least one speaker parameter configuration record matched with the scene type combination of the parameter configuration request.

At block 403, the server transmits a parameter configuration response carrying the speaker parameter configuration record to the mobile terminal.

At block 404, the mobile terminal performs parameter configuration on wireless speakers of the wireless speaker system through the use of the speaker parameter configuration record received.

As one implementation, the process of parameter configuration at block 404 can be achieved as follows: the mobile terminal generates a target speaker parameter configuration record based on the speaker parameter configuration record received and perform configuration on the wireless speakers of the wireless speaker system in accordance with the target speaker parameter configuration record.

In real practice, there can be more than one speaker parameter configuration record received. Based on this, the mobile terminal can generate the target speaker parameter configuration record based on any of a plurality of speaker parameter configuration records received. Or, the mobile terminal can generate the target speaker parameter configuration record based on the all of the plurality of speaker parameter configuration records received.

### Example 1

For example, the mobile terminal can generate the target speaker parameter configuration record based on a plurality of speaker parameter configuration records received as follows: suppose the number of speaker parameter configuration records is N, and in each speaker parameter configuration record, the number of speakers is Y and the number of parameter types is X; based on this fact, in the target speaker parameter configuration record, the value of Parameter j of Speaker i (wherein i is an integer between 1 to Y) is set to be equal to the average value of the sum of Parameters j of Speaker i in each speaker parameter configuration record; wherein Y, X, N are positive integers, Speaker i is any speaker among the speakers (that is, Speaker 1, Speaker 2, . . . Speaker i, . . . , Speaker Y), and Parameter j is any parameter type among the parameter types (that is, Parameter 1, Parameter 2, . . . Parameter j, . . . , Parameter X).

### Example 2

As another example, the mobile terminal can extract a specific speaker parameter configuration record from the plurality of speaker parameter configuration records; the specific speaker parameter configuration record has a minimum relative time difference between a record creating time and a receiving time of the parameter configuration request. Influence of a specific date on the record creating time and/or the receiving time is not considered when determining the relative time difference, which will be defined in the 24-hour system only. For example, suppose the record creating time in the plurality of speaker parameter configuration records is Setting time 1 (7:40′20″ am), Setting time 2 (7:50′30″ am), Setting time 3 (at 7:35′20″ am), and the receiving time of the parameter configuration request is 8:40′20″ am, based on this, the mobile terminal will extract the speaker parameter configuration record corresponding to Setting time 2.

After the target speaker configuration record is generated, the mobile terminal can transmit a configuration instruction to a main speaker of the wireless speaker system via a home network such as a Wi-Fi network, wherein, the configuration instruction is for indicating performing parameter configuration on wireless speakers of the wireless speaker system through the use of the target speaker parameter configuration record. After the configuration instruction is received, the main speaker can transfer the configuration instruction to other wireless speakers of the wireless speaker system via a private network (such as a MESH network) of the wireless speaker system described above, whereby other speakers can perform parameter configuration through the use of the target speaker parameter configuration record.

At block 405, the server acquires a song catalog matched with the scene type combination of the wireless speakers.

At block 406, the server transmits the song catalog to the mobile terminal.

At block 407, the control terminal controls wireless speakers of the wireless speaker system to play songs corresponding to the song catalog. Therefore, the mobile terminal can receive one or more song catalogs sent by the server and control the wireless speaker system to play songs corresponding to the song catalogs received, therefore, convenience of song catalog setting of the wireless speaker system by the mobile terminal can be enhanced and user experience can be improved.

Through the technical scheme described above, the mobile terminal can perform parameter configuration on the wireless speakers of the wireless speaker system through the use of at least one speaker parameter configuration record received from the server. The technical scheme has advantages that, with aid of the speaker parameter configuration record received, active settings can be conducted by the mobile terminal without the need to set manually by user, therefore, convenience of speaker parameter configuration of the mobile terminal can be enhanced and user experience can be improved.

Implementation 4

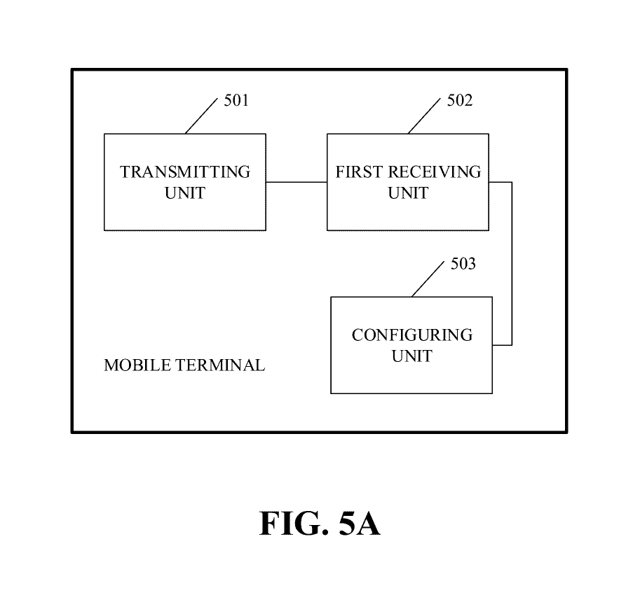

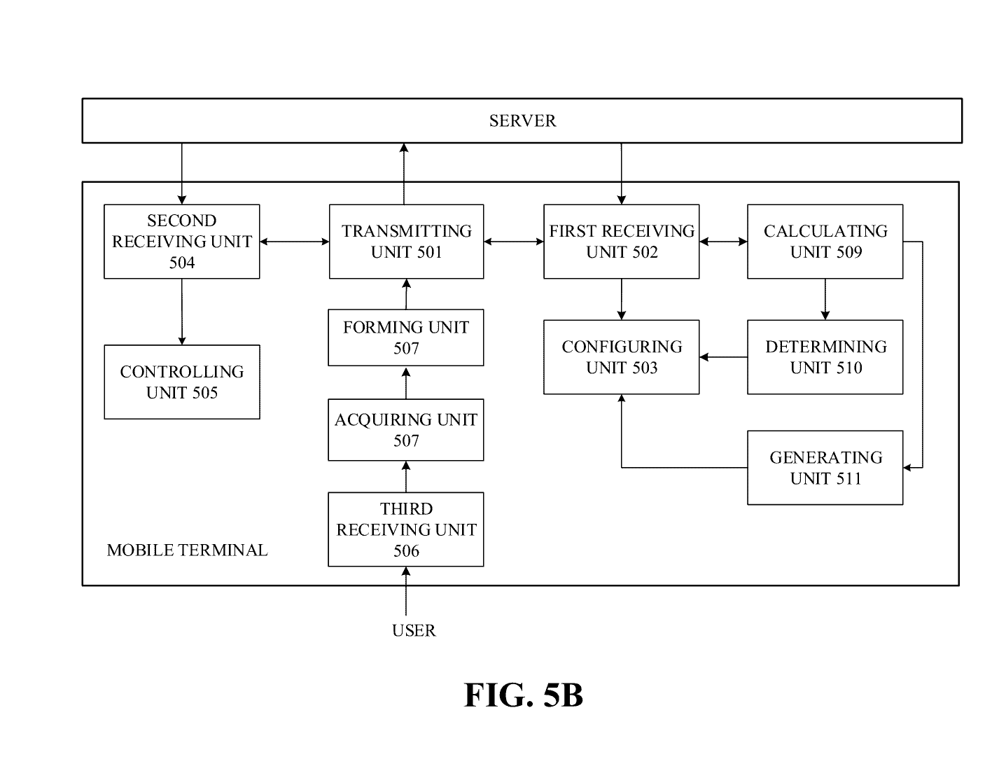

Based on the network architecture of FIG. 1, the present disclosure provides a mobile terminal and FIG. 5A is a structure schematic diagram illustrating the mobile terminal. As illustrated in FIG. 5A, the mobile terminal can include a transmitting unit 501, a first receiving unit 502, and a configuring unit 503, which will be described below in detail.

The transmitting unit 501 such as a transmitter is configured to transmit a parameter configuration request carrying a scene type combination of wireless speakers of a wireless speaker system to a server.

The wireless speaker system is a music playing system including a plurality of speakers (such as a wireless speaker, a Bluetooth speaker, an intelligent speaker, and the like) via a private network (such as a MESH network). In the music playing system, a logical main speaker can be designated to conduct data and control instruction interactions with an APP installed in a control terminal of the user via a home network (such as a Wi-Fi network); after receiving an instruction sent through an APP of the mobile terminal from the user, the main speaker can transfer the instruction to other wireless speakers of the wireless speaker system via the private network of the wireless speaker system.

For example, a wireless speaker system is provided with a bedroom speaker, a living room speaker 1, and a living room speaker 2. Through an APP installed on a smart phone, the user can set the volume of the bedroom speaker to be 10 as well as set the volume of the living room speaker 1 and the living room speaker 2 to be 15, among which the bedroom speaker is designated to be the main device of the wireless speaker system. In this situation, after receiving a control instruction configured to set the volume of the wireless speaker system from the mobile terminal, the bedroom speaker will transfer this control instruction to the living room speaker 1 and the living room speaker 2 respectively via the private network of the wireless speaker system.

The first receiving unit 502 such as a receiver is configured to receive a parameter configuration response sent by the server in response to the parameter configuration request; the parameter configuration response contains at least one speaker parameter configuration record matched with the scene type combination.

The configuring unit 503 such as a processor is configured to perform parameter configuration on the wireless speakers of the wireless speaker system through the use of the speaker parameter configuration record received.

As one implementation, as illustrated in FIG. 5B, the mobile terminal can further include: a second receiving unit 504 such as a receiver, configured to receive at least one song catalog matched with the scene type combination from the server; and a controlling unit 505 such as a controller, configured to control wireless speakers of the wireless speaker system to play songs corresponding to the song catalog.

The transmitting unit 501, the first receiving unit 502, and/or the second receiving unit 504 can be integrated together into a single device with transceiver function.

Through the above technical scheme, the mobile terminal can receive one or more song catalogs sent by the server and control a wireless speaker system to play songs corresponding to the song catalogs received, it can be easy for the mobile terminal to set song catalogs of the wireless speaker system and user experience can be improved.

As illustrated in FIG. 5B, the mobile terminal can further include a third receiving unit 506, an acquiring unit 507, and a forming unit 508.

The third receiving unit 506 is configured to receive a creating instruction concerning the wireless speaker system from a user; the acquiring unit 506 is configured to acquire at least one scene type of the wireless speakers contained in the creating instruction; and the forming unit 507 is configured to form the scene type combination based on the least one scene type acquired, whereby the transmitting unit 501 can transmit the parameter configuration request carrying the scene type combination to the server

Furthermore, as illustrated in FIG. 5B, the mobile terminal can further include a calculating unit 509.

### Example 1

The mobile terminal can further include a determining unit 510.

In this example, the calculating unit 509 is configured to calculate a first relative time difference for each speaker parameter configuration record received by the first receiving unit, wherein,

T=T1−T2

wherein, T is the first relative time difference, T1 is a receiving time of the parameter configuration request by the server, and T2 is a record creating time of each speaker parameter configuration record.

The determining unit 510 is configured to determine a specific speaker parameter configuration record among the at least one speaker parameter configuration record received based on the first relative time difference calculated; and

The configuring unit 503 is further configured to perform parameter configuration through the use of the specific speaker parameter configuration record determined by the determining unit 510.

### Example 2

The mobile terminal can further include a generating unit 511.

In this example, the calculating unit 509 is configured to calculate the parameter value of each parameter type of the target speaker parameter configuration record in accordance with the following formula:

$${P}_{ij} = \frac{1}{N} * {\sum }_{k = 1}^{N} {P}_{ijk}$$

wherein, i, j, k, and N are integers, i is the serial number of a speaker, j is the serial number of a parameter type of the speaker, k is the serial number of a speaker parameter configuration record, and N is the number of the at least one speaker parameter configuration record.

The generating unit 511 is configured to generate a target speaker parameter configuration record from the at least one speaker parameter configuration record; and

The configuring unit 503 is further configured to perform parameter configuration through the use of the target speaker parameter configuration record generated by the generating unit 511.

The function of the mobile terminal can be realized through the methods according to Implementation1 or Implementation 3 of the present disclosure, the realization procedure can be comprehended with refer to relative descriptions of the implementations given above and will not go into much detail here.

Through the technical scheme described above, the mobile terminal, which can perform parameter configuration on the wireless speakers of the wireless speaker system through the use of at least one speaker parameter configuration record received from the server, can be provided. The technical scheme has advantages that, with aid of the speaker parameter configuration record received, active settings can be conducted by the mobile terminal without the need to set manually by user, therefore, convenience of speaker parameter configuration of the mobile terminal can be enhanced and user experience can be improved.

Implementation 5

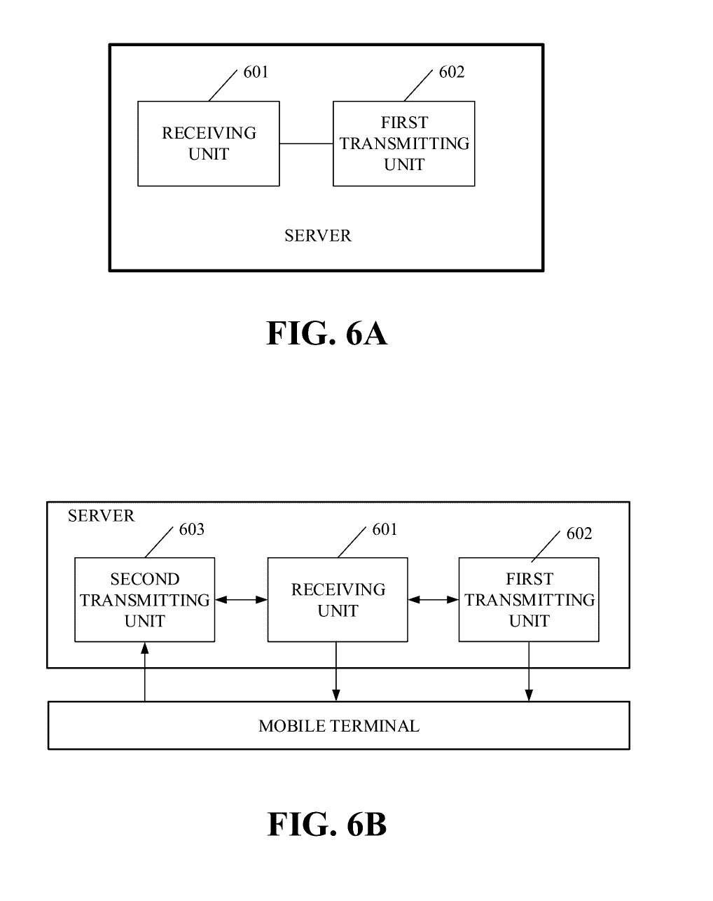

Based on the network architecture illustrated in FIG. 1, the present disclosure further provides a server and FIG. 6A is a structure schematic diagram illustrating the server. As illustrated in FIG. 6A, the server can include a receiving unit 601 and a first transmitting unit 602, which will be described below in detail.

The receiving unit 601 such as a receiver is configured to receive a parameter configuration request carrying a scene type combination of wireless speakers of a wireless speaker system from a mobile terminal.

The first transmitting unit 602 such as a transmitter is configured to transmit a parameter configuration response carrying at least one speaker parameter configuration record matched with the scene type combination to the control terminal, whereby the mobile terminal can perform parameter configuration on the wireless speakers of the wireless speaker system through the use of the speaker parameter configuration record received.

As one implementation, as illustrated in FIG. 6B, the server according to this implementation can still include a second transmitting unit 603 such as a transmitter, which is configured to transmit at least one song catalog matched with the scene type combination of the wireless speakers to the mobile terminal, whereby the mobile terminal can control wireless speakers of the wireless speaker system to play songs corresponding the song catalog.

The receiving unit 601, the first transmitting unit 602, and/or the second transmitting unit 603 can be can be integrated together into a single device with transceiver function.

The function of the server can be realized through the methods according to Implementation 2 or Implementation 3 of the present disclosure, the realization procedure can be comprehended with refer to relative descriptions of the implementations given above and will not go into much detail here.

Through the technical scheme described above, the server illustrated can receive the parameter configuration request carrying the scene type combination of wireless speakers of the wireless speaker system and in response thereto, return the parameter configuration response containing the speaker parameter configuration record matched with the scene type combination; whereby the mobile terminal can perform parameter configuration on the wireless speakers of the wireless speaker system through the use of the speaker parameter configuration record received. The technical scheme has advantages that, with aid of the speaker parameter configuration record received, active settings can be conducted by the mobile terminal without the need to set manually by user, therefore, convenience of speaker parameter configuration of the mobile terminal can be enhanced and user experience can be improved.

Furthermore, as described above, the server provided in this implementation can transmit one or more song catalogs to the mobile terminal whereby a wireless speaker system can be controlled to play the songs corresponding to the song catalogs received, it can be easy for the mobile terminal to set song catalogs of the wireless speaker system and user experience can be improved.

Implementation 6

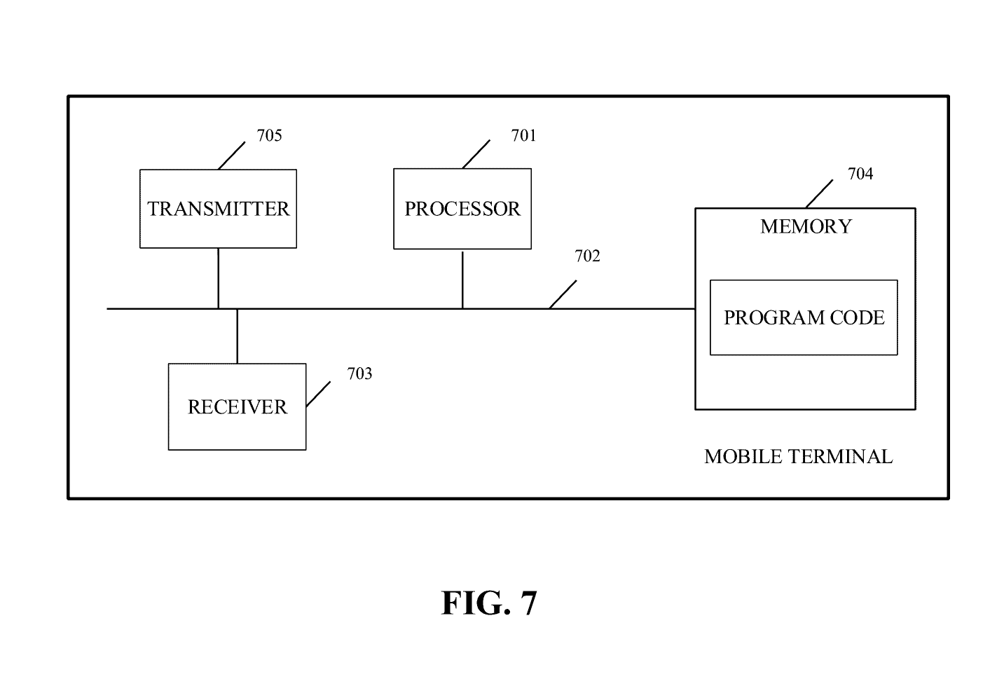

Based on the network architecture of FIG. 1, the present disclosure provides another mobile terminal and FIG. 7 is a structure schematic diagram illustrating the mobile terminal. As illustrated in FIG. 7, the mobile terminal can include at least one processor 701 such as a CPU, at least one receiver 703, at least one memory 704, at least one transmitter 705, and at least one communication bus 702. The communication bus 702 is arranged for connection communication among these components. The receiver 703 and the transmitter 705 can be a wired transmission interface or wireless equipment such as an antenna device respectively, and is arranged for signaling or data communication with other node equipment. The memory 704 can be a high speed RAM memory or non-volatile memory; for example, it can be at least one disk memory. As another instance, the memory 704 can be at least one storing device away from the processor 701. The memory 704 is further configured to store a set of program code, when invoked by the processor 701, the program code adapted to perform the following processes:

transmitting a parameter configuration request carrying a scene type combination of wireless speakers of a wireless speaker system to a server;

receiving a parameter configuration response sent by the server in response to the parameter configuration request; the parameter configuration response contains a speaker parameter configuration record matched with the scene type combination; and

performing parameter configuration on the wireless speakers of the wireless speaker system through the use of the speaker parameter configuration record received.

As one implementation, after the process of parameter configuration, the processor 701 can further invoke the program code to perform the following processes: receiving a song catalog matched with the scene type combination from the server; and controlling the wireless speakers of the wireless speaker system to play songs corresponding to the song catalogs.

Therefore, the mobile terminal can receive one or more song catalogs sent by the server and control the wireless speaker system to play songs corresponding to the song catalogs received, it can be easy for the mobile terminal to set song catalogs of the wireless speaker system and user experience can be improved.

As one implementation, the process of transmitting the parameter configuration request carrying the scene type combination of wireless speakers of the wireless speaker system to the server performed by the processor 701 can be achieved as follows: receiving a creating instruction with regard to the wireless speaker system sent by user; acquiring the scene type combination formed by scene types of the wireless speakers added in the creating instruction; and transmitting the parameter configuration request carrying the scene type combination of the wireless speakers to the server.

The function of the mobile terminal can be realized through the methods according to implementations of the present disclosure and the realization procedure can be comprehended with refer to relative descriptions of the implementations given above and will not go into much detail here.

Through the technical scheme described above, the mobile terminal illustrated can transmit the parameter configuration request carrying the scene type combination of wireless speakers of a wireless speaker system to the server and then receive a parameter configuration response, which is transmitted by the server in response to the parameter configuration request and contains at least one speaker parameter configuration record matched with the scene type combination; besides, the mobile terminal can perform parameter configuration on the wireless speakers of the wireless speaker system through the use of the speaker parameter configuration record received. The technical scheme has advantages that, with aid of the speaker parameter configuration record received, active settings can be conducted by the mobile terminal without the need to set manually by user, therefore, convenience of speaker parameter configuration of the mobile terminal can be enhanced and user experience can be improved.

Implementation 7

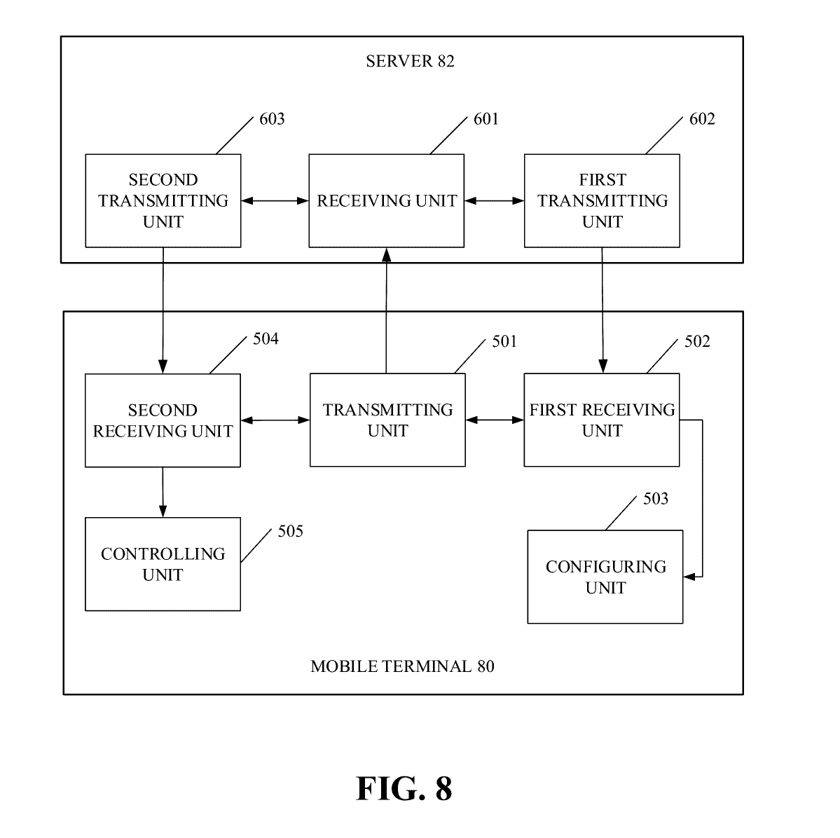

According to another implementation of the present disclosure, it is provided a speaker parameter configuration system and FIG. 8 is an architecture diagram illustrating the system. As illustrated in FIG. 8, the speaker parameter configuration system can include a mobile terminal 80 and a server 82.

The mobile terminal 80 includes a transmitting unit 501, a first receiving unit 502, and a configuring unit 503. The server 82 includes a receiving unit 601 and a first transmitting unit 602.

The transmitting unit 501 is configured to transmit a parameter configuration request carrying a scene type combination of wireless speakers of a wireless speaker system to the server.

The receiving unit 601 is configured to receive the parameter configuration request and inquire a speaker parameter configuration record matched with the scene type combination of the parameter configuration request.

The first transmitting unit 602 is configured to transmit a parameter configuration response carrying the speaker parameter configuration record inquired to the mobile terminal.

The configuring unit 503 is configured to perform parameter configuration on the wireless speakers of the wireless speaker system through the use of the speaker parameter configuration record received by the first receiving unit 502.

For instance, the process of parameter configuration can be implemented as follows: generating a target speaker parameter configuration record based on the speaker parameter configuration record received and performing configuration on the wireless speakers of the wireless speaker system in accordance with the target speaker parameter configuration record generated.

In real practice, there can be more than one speaker parameter configuration record received.

Based on this, the mobile terminal can generate the target speaker parameter configuration record based on any of a plurality of speaker parameter configuration records received. Or, the mobile terminal can generate the target speaker parameter configuration record based on the all of the plurality of speaker parameter configuration records received.

For example, the mobile terminal can generate the target speaker parameter configuration record based on a plurality of speaker parameter configuration records received as follows: suppose the number of speaker parameter configuration records is N, and in each speaker parameter configuration record, the serial number of a speaker is Y and the number of parameter types is X; based on this fact, in the target speaker parameter configuration record, the value of Parameter j (wherein j is an integer between 1 to X) of Speaker i (wherein i is an integer between 1 to Y) is set to be equal to the average value of the sum of Parameters j of Speaker i in each speaker parameter configuration record; wherein Y, X, N are positive integers, Speaker i is any speaker among the speakers (that is, Speaker 1, Speaker 2, . . . Speaker i, . . . , Speaker Y), and Parameter j is any parameter type among the parameter types (that is, Parameter 1, Parameter 2, . . . Parameter j, . . . , Parameter X).

As another example, the mobile terminal can extract a specific speaker parameter configuration record from the plurality of speaker parameter configuration records; the specific speaker parameter configuration record has a minimum relative time difference between a record creating time and a receiving time of the parameter configuration request. Influence of a specific date on the record creating time and/or the receiving time is not considered when determining the relative time difference, which will be defined in the 24-hour system only. For example, suppose the record creating time in the plurality of speaker parameter configuration records is Setting time 1 (7:40′20″ am), Setting time 2 (7:50′30″ am), Setting time 3 (7:35′20″ am), and the receiving time of the parameter configuration request is 8:40′20″ am, based on this, the mobile terminal will extract the speaker parameter configuration record corresponding to Setting time 2.

After the target speaker configuration record is generated, the mobile terminal can transmit a configuration instruction to a main speaker of the wireless speaker system via a home network such as a Wi-Fi network, wherein, the configuration instruction is for indicating performing parameter configuration on wireless speakers of the wireless speaker system through the use of the target speaker parameter configuration record. After the configuration instruction is received, the main speaker can transfer the configuration instruction to other wireless speakers of the wireless speaker system via a private network (such as a MESH network) of the wireless speaker system described above, whereby other speakers can perform parameter configuration through the use of the target speaker parameter configuration record.

In one implementation, the mobile terminal 80 further includes a second receiving unit 504 and a controlling unit 505. The server 82 further includes a second transmitting unit 603.

The second transmitting unit 603 is configured to acquire a song catalog matched with the scene type combination of the wireless speakers and transmit the song catalogs to the mobile terminal.

The controlling unit 505 is configured to control wireless speakers of the wireless speaker system to play songs corresponding to the song catalog received by the second receiving unit 504.

Therefore, of the speaker parameter configuration system, the mobile terminal can receive one or more song catalogs sent by the server and control the wireless speaker system to play the songs corresponding to the song catalogs received, it can be easy for the mobile terminal to set song catalogs of the wireless speaker system and user experience can be improved.

Through the technical scheme described above, the speaker parameter configuration system can perform parameter configuration on the wireless speakers of the wireless speaker system through the use of the speaker parameter configuration record received by the mobile terminal from the server. The technical scheme has advantages that, with aid of the speaker parameter configuration record received, active settings can be conducted by the mobile terminal without the need to set manually by user, therefore, convenience of speaker parameter configuration of the mobile terminal can be enhanced and user experience can be improved.

It should be noted that, for each method of the aforementioned implementations, for ease of description, it has been referred to as a combination of a series of actions, those skilled in the art should be aware that this disclosure is not restricted by the sequence of the actions, in contradistinction, some steps can be performed in other sequence or simultaneously. In addition, those skilled in the art should also be aware that implementations described herein are exemplary implementations only, operations and units involved are not necessarily for the implementation of the present disclosure.

Description of each implementation focuses on different technical schemes; for contents not described in detail in one implementation, please refer to relative descriptions in other implementations.

Those skilled in the art should be noted that all or part of the steps of each method described above can be implemented through program instruction related hardware; the program instruction can be stored in a computer readable storage medium such as a flash memory, Read-Only memory (ROM), Random Access memory (RAM), disk, and CD.

The foregoing descriptions are merely exemplary implementations rather than restriction of the present disclosure. Various modifications and alterations can be made to the present disclosure for those skilled in the art. Any modification, equivalent substitution, improvement or the like made within the spirit and principle of the present disclosure shall fall into the protection scope thereof.

What is claimed is:

1. A method for speaker parameter configuration, comprising:
transmitting a parameter configuration request comprising a scene type combination of wireless speakers of a wireless speaker system to a server;
receiving a parameter configuration response sent from the server in response to the parameter configuration request, wherein the parameter configuration response comprises at least one speaker parameter configuration record matched with the scene type combination; and
performing parameter configuration on the wireless speakers of the wireless speaker system by using the at least one speaker parameter configuration record received.

2. The method of claim 1, wherein after performing parameter configuration on the wireless speakers, the method further comprising:
receiving at least one song catalog matched with the scene type combination from the server; and
controlling the wireless speakers of the wireless speaker system to play songs of all or part of the at least one song catalog.

3. The method of claim 1, wherein prior to transmitting the parameter configuration request to the server, the method further comprising:
receiving a creating instruction concerning the wireless speaker system from a user; and
acquiring at least one scene type of the wireless speakers comprised in the creating instruction to form the scene type combination.

4. The method of claim 1, wherein performing parameter configuration on the wireless speakers of the wireless speaker system by using the at least one speaker parameter configuration record received comprises:
calculating a first relative time difference for each speaker parameter configuration record according to the following:
T=T1−T2
wherein T is a first relative time difference, T1 is a receiving time of the parameter configuration request by the server, and T2 is a record creating time of each speaker parameter configuration record;
determining a specific speaker parameter configuration record among the at least one speaker parameter configuration record received based on the first relative time difference calculated; and
performing parameter configuration by using the specific speaker parameter configuration record.

5. The method of claim 4, wherein the specific speaker parameter configuration record comprises a minimum first relative time difference.

6. The method of claim 1, wherein performing parameter configuration on the wireless speakers of the wireless speaker system by using the at least one speaker parameter configuration record received comprises:
generating a target speaker parameter configuration record from the at least one speaker parameter configuration record; and
performing parameter configuration by using the target speaker parameter configuration record.

7. The method of claim 6, wherein generating the target speaker parameter configuration record comprises:
calculating a parameter value of each parameter type of the target speaker parameter configuration record in accordance with the following:
$${P}_{ij} = \frac{1}{N} * {\sum }_{k = 1}^{N} {P}_{ijk}$$
wherein, i, j, k, and N are integers, i is a serial number of a speaker, j is a serial number of a parameter type of the speaker, k is a serial number of a speaker parameter configuration record, and N is a number of the at least one speaker parameter configuration record.

8. The method of claim 1, wherein performing parameter configuration on the wireless speakers of the wireless speaker system by using the at least one speaker parameter configuration record received comprises:
transmitting a configuration instruction to a main speaker of the wireless speaker system, and
wherein the configuration instruction is for indicating performing parameter configuration on the wireless speakers of the wireless speaker system by using the at least one speaker parameter configuration record, whereby the main speaker will transfer the configuration instruction to other speakers of the wireless speaker system through a private network.

9. A method for speaker parameter configuration, comprising:
receiving a parameter configuration request comprising a scene type combination of wireless speakers of a wireless speaker system from a mobile terminal; and
transmitting a parameter configuration response comprising at least one speaker parameter configuration record matched with the scene type combination to a control terminal.

10. The method of claim 9, after transmitting the parameter configuration response to a control terminal, the method further comprising:
transmitting at least one song catalog matched with the scene type combination to the mobile terminal.

11. The method of claim 9, wherein transmitting the at least one song catalog to the mobile terminal comprises:
calculating a second relative time difference for each song catalog according to the following:
T′=T1−T3
wherein T′ is the second relative time difference, T1 is a receiving time of the parameter configuration request by a server, and T3 is a catalog creating time of each song catalog;
determining a specific song catalog that comprises a minimum second relative time difference; and
transmitting the specific song catalog to the mobile terminal.

12. A mobile terminal, comprising:
a transmitting unit, configured to transmit a parameter configuration request comprising a scene type combination of wireless speakers of a wireless speaker system to a server;
a first receiving unit, configured to receive a parameter configuration response sent by the server in response to the parameter configuration request, wherein the parameter configuration response comprises at least one speaker parameter configuration record matched with the scene type combination; and
a configuring unit, configured to perform parameter configuration on the wireless speakers of the wireless speaker system by using the at least one speaker parameter configuration record received.

13. The mobile terminal of claim 12, further comprising:
a second receiving unit, configured to receive at least one song catalog matched with the scene type combination from the server; and
a controlling unit, configured to control the wireless speakers of the wireless speaker system to play songs of all or part of the at least one song catalog.

14. The mobile terminal of claim 12, further comprising:
a third receiving unit, configured to receive a creating instruction concerning the wireless speaker system from a user;
an acquiring unit, configured to acquire at least one scene type of the wireless speakers comprised in the creating instruction; and
a forming unit, configured to form the scene type combination based on the at least one scene type acquired.

15. The mobile terminal of claim 12, further comprising:
a calculating unit, configured to calculate a first relative time difference for each speaker parameter configuration record received by the first receiving unit based on the following:
T=T1−T2
wherein T is a first relative time difference, T1 is a receiving time of the parameter configuration request by the server, and T2 is a record creating time of each speaker parameter configuration record;
a determining unit, configured to determine a specific speaker parameter configuration record among the at least one speaker parameter configuration record received based on the first relative time difference calculated; and
the configuring unit is further configured to perform parameter configuration by using the specific speaker parameter configuration record.

16. The mobile terminal of claim 12, further comprising:
a calculating unit, configured to calculate a parameter value of each parameter type of a target speaker parameter configuration record in accordance with:
$${P}_{ij} = \frac{1}{N} * {\sum }_{k = 1}^{N} {P}_{ijk}$$
wherein, i, j, k, and N are integers, i is a serial number of a speaker, j is a serial number of a parameter type of the speaker, k is a serial number of a speaker parameter configuration record, and N is a number of the at least one speaker parameter configuration record;
a generating unit, configured to generate the target speaker parameter configuration record from the at least one speaker parameter configuration record; and
the configuring unit is further configured to perform parameter configuration by using the target speaker parameter configuration record.
